(19) United States
(12) Patent Application Publication
(10) Pub. No.: US 2015/0156992 A1
(43) Pub. Date: Jun. 11, 2015

(54) METHOD FOR FEEDING POULTRY

(71) Applicants: Nihon Funen Co., Ltd., Yoshinogawa-shi, Tokushima (JP); Tokushima Prefecture, Tokushima-shi, Tokushima (JP)

(72) Inventors: Takeshi Kasahara, Tokushima-shi (JP); Masaaki Shimizu, Tokushima-shi (JP); Tatsuji Matsunaga, Tokushima-shi (JP); Tokuo Kume, Yoshinogawa-shi (JP); Takahiro Wada, Yoshinogawa-shi (JP); Kenichi Yoshida, Yoshinogawa-shi (JP); Masayuki Okamoto, Yoshinogawa-shi (JP); Chikamitsu Ohshima, Myouzai-gun (JP); Shigeki Doi, Myouzai-gun (JP)

(21) Appl. No.: 14/411,451

(22) PCT Filed: Feb. 4, 2014
(86) PCT No.: PCT/JP2014/000559

§ 371 Date: Dec. 26, 2014

(30) Foreign Application Priority Data
Feb. 7, 2013 (JP) 2013-022459

(51) Int. Cl. A01K 31/22; A01K 45/00

(52) U.S. Cl. CPC A01K 31/22; A01K 45/00

(57) ABSTRACT

A method for producing poultry for raising poultry with high production score is provided.

In a method for producing poultry in a poultry house, a feeding area for feeding the poultry is illuminated with blue light in an early raising period of a poultry raising period. In the early raising period, behavior of chicks can be restricted by illuminating the feeding area with blue light. Accordingly, sudden death of chick or metabolic disorder due to excessive and abrupt behavior of chick can be prevented, and thus chicks not having injury or diseases such as metabolic disorder can be raised, and physical conditions of the grown poultry can be improved.

### TECHNICAL FIELD

The present invention relates to a method of feeding poultry. More specifically, the present invention relates to a method of feeding poultry for feeding edible poultry in a poultry house.

### BACKGROUND ART

Industry of feeding poultry such as chickens, quails, ducks and geese (hereinafter, simply referred to as poultry industry) is very popular in various countries in the world including Japan, and a method that allows efficient growth of poultry is demanded in feeding of edible poultry. As an index for evaluating such efficiency, a production score is employed. The production score is general evaluation of productivity of poultry based on an average body weight, a rate of raising, a feed conversion rate and day of age at shipment, and in particular, the average body weight at shipment of poultry and the rate of raising of poultry are important requirements.

Poultry feeding methods conventionally adopted in the poultry industry assume that a certain proportion of chicks die in an early period of feeding poultry, and place great importance on how the alive poultry are fed to have a desired body weight at shipment (for example, Patent Document 1).

Patent Document 1 discloses a feeding method in which illumination in the poultry house is made bright in an early feeding period, and the illumination is made dark at the time of shipment. Concretely, it discloses a method for feeding chickens including adjusting the illumination inside the poultry house to brightness of 20 1× in the early feeding period, and then gradually darkening the illumination to brightness of about 2 to 3 1× at the time of shipment. This document also describes that this method makes it possible to increase the body weight of poultry in a short time because the poultry can be fed in such a condition that they can take feeds frequently, and makes it possible to further increase the body weight of the poultry by suppressing behavior of the poultry because they are fed under very dark illumination of about 2 to 3 1× at the time of shipment.

### PRIOR ART DOCUMENTS

### Patent Documents

Patent Document 1: JP-A-2009-171866

### SUMMARY OF THE INVENTION

### Problems to be Solved by the Invention

While the feeding method of Patent Document 1 considers the average body weight at the shipment of poultry, it little considers the rate of raising of poultry. In other words, Patent Document 1 completely lacks a description of the rate of raising although it has a description of fattening method. In addition, in the feeding method of Patent Document 1, since the poultry are fed in a bright condition in an early feeding period when the poultry are chicks (namely, in the condition that the chicks can actively behave), death by crash or injury can frequently occur due to mutual pecking or an unexpected action caused by stresses occurring due to impossibility of taking appropriate rests, or chicks can easily get ill. Since the feeding method of Patent Document 1 is a feeding method based on the assumption that a considerable number of chicks die in the early feeding period, although it can feed the poultry to have a desired body weight at shipment, it achieves poor raising performance, or in other words, it has a difficulty in raising poultry with a high production score.

In light of the aforementioned circumstances, it is an object of the present invention to provide a method for feeding poultry that raises poultry with a high production score.

### Means for Solving the Problems

A method for producing poultry according to the first aspect of the invention is a method for producing poultry in a poultry house, wherein in an early raising period of a poultry raising period, a feeding area for feeding the poultry is illuminated with blue light.

A method for producing poultry according to the second aspect of the invention is characterized in that the blue light illuminates throughout the poultry raising period in the first aspect of the present invention.

A method for producing poultry according to the third aspect of the invention is characterized in that in a late raising period of the poultry raising period, the feeding area is illuminated with white light in the first or second aspect of the invention.

A method for producing poultry according to the fourth aspect of the invention is characterized in that in a transition period that is between the early raising period and the late raising period, the feeding area is illuminated with light of an intermediate color that is between the blue light and the white light, in the third aspect of the invention.

A method for producing poultry according to the fifth aspect of the invention is characterized in that a preparatory period is provided before the early raising period and/or in an initial period of the early raising period, and the feeding area is illuminated with non-blue light in the preparatory period, in the first, second, third or fourth aspect of the invention.

A method for producing poultry according to the sixth aspect of the invention is characterized in that illuminance of light for illuminating the feeding area in the late raising period is adjusted so that illuminance in the late raising period is higher than illuminance in the early raising period, in the first, second, third, fourth or fifth aspect of the invention.

A method for producing poultry according to the seventh aspect of the invention is characterized in that illuminance of light in the late raising period is more than or equal to 30 1×, in the sixth aspect of the invention.

A method for producing poultry according to the eighth aspect of the invention is characterized in that illuminance of light in the early raising period is less than or equal to 15 1×, in the sixth or seventh aspect of the invention.

A method for producing poultry according to the ninth aspect of the invention is characterized in that illuminance of light in the transition period is more than or equal to illuminance of light in the early raising period and less than or equal to illuminance of light in the late raising period, in the eighth aspect of the invention.

### Effect of the Invention

According to the first aspect of the invention, it is possible to restrict behavior of chicks because the feeding area is illuminated with blue light in the early raising period. Therefore, sudden death of chick or metabolic disorder due to excessive and abrupt behavior of the chick can be prevented, and thus chicks not having injury or diseases such as metabolic disorder can be raised, and physical conditions of grown poultry can be improved.

According to the second aspect of the invention, it is possible to raise poultry in the condition that their behavior is restricted throughout the raising period. In brief, it is possible to keep the mortality of poultry low throughout the raising period. In other words, since poultry can be raised with high rate of raising throughout the period from placement of chicks of poultry to shipment, the poultry can be raised with a high production score.

According to the third aspect of the invention, since the feeding area is illuminated with white light in the late raising period prior to shipment of the poultry, the poultry become excited. In other words, since the poultry are under the condition that they take feeds more frequently by stimulation of behavior of the poultry in the period for fattening the poultry, the body weight of poultry at shipment can be further increased.

According to the fourth aspect of the invention, since the light for illuminating the feeding area can be changed smoothly between the early raising period and the late raising period of the poultry, it is possible to prevent the poultry from being injured, dying or temporarily decreasing eating due to abrupt environmental change.

According to the fifth aspect of the invention, since the physically weak chicks can be brought into acclimated to the feeding environment by illumination of the feeding area with non-blue light in the preparatory period, it is possible to further improve the survival rate of the chicks. As a result, it is possible to further improve the rate of raising in the period of chicks.

According to the sixth aspect of the invention, since the poultry are raised while their behavior is further stimulated in the late raising period, it is possible that the poultry takes more feeds.

According to the seventh aspect of the invention, it is possible that the poultry is raised to securely have a desired body weight at shipment at a desired shipment time.

According to the eighth aspect of the invention, since the chicks are raised with the illuminance that restricts behavior of the chicks, it is possible to further reduce the mortality of the chicks, and to raise more healthy chicks, and thus it is possible to improve physical conditions of the grown poultry.

According to the ninth aspect of the invention, since illuminance of the light for illuminating the feeding area can be changed more smoothly between the early raising period and the late raising period, it is possible to make the feeding environment into a better condition.

### BRIEF DESCRIPTION OF THE DRAWINGS

FIGS. 1A and 1B are schematic illustrations of a poultry house employing a method for feeding poultry of the present embodiment, wherein 1A is a schematic section view of the poultry house, and 1B is an enlarged schematic section view of a principal part of FIG. 1A.

FIG. 2 is a graph showing an experimental result (rate of raising).

FIG. 3 is a graph showing an experimental result (production score).

### MODE FOR CARRYING OUT THE INVENTION

Next, an embodiment of the present invention will be described by referring to attached drawings.

The method for producing poultry of the present invention is a method for producing poultry in a poultry house, and has a feature that the rate of raising can be improved and poultry can be raised with a high production score by adjusting the light illuminating the area for feeding poultry (hereinafter, simply referred to as feeding area) to have a predetermined color tone. Concretely, poultry are raised by illuminating the feeding area with blue light in the period of chicks (hereinafter, referred to as early raising period).

It has been generally believed that, in feeding of poultry, the light illuminating the feeding area in the early raising period should allow chicks to actively behave and to take feeds frequently. In contrast to this, the inventors found that illumination of the feeding area with the light of the aforementioned color in the early raising period makes it possible to raise poultry with a high production score and accomplished the present invention.

The early raising period used herein means the feeding period from the point of time when chicks are placed in the poultry house to the time when initial growth is achieved. For example, in the case of raising broilers as the poultry, the period from the placement of chicks to about 3 weeks of age corresponds to the early raising period.

The late raising period means the period from attainment of growth of poultry to the shipment, and concretely means the period in which poultry are fattened to have a desired body weight at shipment (so-called fattening period). For example, when broilers are raised as the poultry, the period from about 5 weeks of age to about 7 weeks of age corresponds to the late raising period.

Further, the raising period between the early raising period and the late raising period corresponds to a transition period as described in claims, and when broilers are raised as the poultry, for example, the period from about 3 weeks of age to about 5 weeks of age corresponds to the transition period.

The rate of raising used herein means the proportion of the number of chickens at shipment to the number of chicks at placement, and can be represented by: rate of raising (%)=number of chickens at shipment/number of chicks at placement×100.

Furthermore, the production score is general evaluation of productivity of poultry based on the average body weight, the rate of raising, the feed conversion rate and the day of age at shipment, and can be represented by: production score=(average body weight at shipment×rate of raising)/(feed conversion rate×day of age at shipment)×100. This indicates that the higher the production score, the better the raising performance of poultry, and thus the more excellent the productivity. The feed conversion rate means a feed intake amount required for increasing the body weight of poultry by 1 gram.

The poultry house used in the method for producing poultry of the present invention is not particularly limited as far as it is a poultry house in which light in the feeding area can be adjusted to desired light, and, for example, a poultry house with a window on a wall or the ceiling (so-called open poultry house), and a poultry house without a window on a wall or the ceiling (so-called windowless poultry house) can be recited.

Hereinafter, the case of feeding broilers in an open poultry house according to the method for producing poultry of the present invention will be described as a representative example.

The method for producing poultry of the present invention includes placing broiler chicks in the condition that the feeding area is illuminated with blue light from a plurality of light sources installed above the feeding area in the open poultry house, and raising the broilers until shipment in the same condition.

Preferably, the light source can preferably adjust the color tone of the light emitted from the light source, and it is preferred to employ, for example, a LED light source in which a plurality of illuminants provided in the light source are able to emit different lights because the color of light can be adjusted to a desired color, and the light intensity of the light emitted from the LED light source can be easily adjusted as will be described later, and thus the brightness of the feeding area can be easily adjusted to desired brightness. It is also preferred to employ a LED light source from the economical aspect because power consumption is reduced compared with the conventional incandescent lamp or the like.

As described above, when the broilers are raised from the chicks while the feeding area is illuminated with blue light as described above, they can be raised while behavior of chicks is restricted because the feeding area is illuminated with blue light in the early raising period. Therefore, in the chick period in which they are physically weak, the chicks can be raised in a feeding environment where they can take appropriate rests, and excessive behavior can be restricted, and thus death or the like of chick can be prevented. Concretely, when chicks are raised in an environment where the chicks get excited (namely, in an environment where behavior of chicks is stimulated), the chicks would start mutual pecking, or some individuals can act unexpectedly, however, when chicks are raised in an environment under blue light, appearance of the chicks acting as described above can be prevented.

In addition, since chicks are raised in the condition that their behavior is restricted in the chick period, excessive and abrupt eating behavior can also be restricted, and thus chicks not having disorders such as metabolic disorder due to such a behavior can be raised. Therefore, physical conditions of the grown poultry can also be improved.

Thus, since behavior of chicks can be restricted by illuminating the feeding area with blue light in the early raising period, sudden death of chick or metabolic disorder associated with rapid meat production can be prevented, and thus it is possible to improve physical conditions of the grown poultry, and to improve the feed efficiency and the body weight gain in comparison with the case where they are raised under stress.

Also, when the broilers are raised while the feeding area is illuminated with blue light throughout the raising period from the early raising period to the shipment time, it is possible to raise the broilers in the condition that their behavior is restricted throughout the raising period from they are chicks until they are shipped as grown broilers. In other words, it is possible to raise the broilers with a low mortality throughout the raising period.

In other words, it is possible to raise the broilers with a low mortality in every period during the period from placement of broiler chicks into the poultry house to shipment, namely in each growth stage in raising the broilers (the early raising period, the transition period and the late raising period). Therefore, it is possible to raise the broilers with a high rate of raising throughout the raising period, so that is possible to raise the broilers with a high production score. The reasons can be described as follows.

As described above, the production score can be represented by (average body weight at shipment×rate of raising)/(feed conversion rate×day of age at shipment)×100, and the most important factor among these factors is rate of raising (%) indicating the proportion of the number of chickens at shipment to the number of chicks at placement. In other words, the rate of raising is an important factor for obtaining a high production score. When the rate of raising can be kept high, the production score can also be kept high.

Therefore, by employing the method for producing poultry of the present invention, it is possible to keep a high rate of raising throughout the raising period as described above, and to raise the poultry while keeping a high production score. In other words, it is possible to produce the poultry while keeping high raising performance by the method for producing poultry of the present invention.

In addition, it is possible to raise the boilers having improved physical conditions compared with those raised by a commonly employed feeding method (for example, when the chicks are raised in an environment where behavior of the chicks is stimulated) by raising healthy chicks not having disorders such as metabolic disorder as described above. As a result, the body weight of broilers increases relatively to the amount of taken feed in the late raising period which is the fattening period prior to shipment. As a result, it is possible to increase the value of average body weight at shipment, and to decrease the value of feed conversion rate and the value of day of age at shipment in the production score, so that it is possible to raise the poultry while keeping a higher production score.

As the blue light as described above, those having a peak wavelength within the range from 380 nm to 490 nm are preferred because broilers can be raised in a good feeding environment where behavior of the broilers is restricted as described above. It goes without saying that the blue light is only required to contain the aforementioned wavelength, and it may contain a wavelength of yellow, a wavelength of green and so on other than the aforementioned wavelength.

In particular, by adjusting the light for illuminating the feeding area so that the grown broilers can take feeds frequently in the late raising period, it is possible to increase the body weight of broilers to a desired body weight in a short time. Concretely, the light illuminating the feeding area in the late raising period is made to have a color tone that makes broilers excited. In other words, it is made to have a color tone that stimulates behavior of the broilers.

For example, by employing white light as the light for illuminating the feeding area in the late raising period, it is possible to allow the broilers in this area actively behave. Thus the broilers which are in excited condition, take more feed, and hence the body weight of broilers also increases with the feed intake amount. As a result, it is possible to increase the body weight of the broilers to a desired body weight at shipment during the short late raising period. In other words, by making the broilers excited in the period of fattening the poultry (late raising period), the broilers take feeds more frequently, so that the body weight at shipment of the broilers can be further increased.

Therefore, it is possible to further increase the value of average body weight at shipment, and to further decrease the value of day of age at shipment in the aforementioned production score. In other words, by illuminating the feeding area with blue light in the early raising period, and illuminating the feeding area with white light in the late raising period, it is possible to improve the rate of raising, and to raise the broilers to have a desired body weight at shipment in a short time, and thus it is possible to raise the broilers with a higher production score. In other words, it is possible to further improve the raising performance in production of broilers.

The white light as described above is able to make the broilers excited when its wavelength contains the wavelength of the blue light (having a peak wavelength within the range from 380 nm to 490 nm).

In the transition period between the early raising period and the late raising period, it is preferred to adjust the light for illuminating the feeding area so that the light does not change abruptly from the light for illumination in the early raising period to the light for illumination in the late raising period.

For example, when the light for illumination in the early raising period is blue light, and the light for illumination in the late raising period is white light, the light for illuminating the feeding area in the transition period is adjusted to have an intermediate color (for example, pale blue light) between the blue light and the white light. This allows smooth transition of the feeding environment of the feeding area between the early raising period and the late raising period. Therefore, it is possible to prevent occurrence of an abrupt environmental change in the feeding area in the transition period between the early raising period and the late raising period, and thus it is possible to prevent the poultry from being injured or dying, or temporarily showing significant decrease in eating due to an abrupt environmental change.

As a result, even when the color tone of the light for illuminating the feeding area changes between the early raising period and the late raising period, it is possible to raise the broilers without any stress in the feeding area in the transition period between these periods irrespectively of the color tone of the light in the feeding area in the raising periods before and after the transition period. In other words, by adjusting the color tone of the light for illuminating the feeding area in the transition period, it is possible to keep a high rate of raising even in the transition period.

It goes without saying that the light in the transition period is not limited to the light of an intermediate color as described above, and the light emitted from the light source may be gradually modulated from the light for illumination in the early raising period to the light for illumination in the late raising period.

(Regarding LED Light Source)

In the case of illuminating the feeding area with light by using a LED light source, the color tone can be adjusted so that the light for illuminating the feeding area is desired light. Concretely, an LED light source in which a predetermined number of LED devices respectively emitting light of red (R), blue (B) and green (G) are arranged on a substrate can be employed. Non-limiting examples of the arrangement form of the LED devices include a linear arrangement and a concentric arrangement.

When the aforementioned LED light source is used, white light may be adjusted by mixing the lights emitted from the respective LED devices at a predetermined ratio, and the feeding area may be illuminated with the resultant white light in the late raising period. Concretely, the light intensities emitted from the respective LED devices are adjusted so that the color temperature of the white light emitted from the LED light source is 5000 to 7000 kelvin. More concretely, when the maximum output of each LED device is 10, the output of the LED device may be 4 to 6 for blue light, 9 for red light and 7 to 9 for green light.

(Regarding Preparatory Period)

In the above example, the case of raising broilers from placement of chicks until shipment has been described, however, a certain period (for example, about 3 days) may be provided after placement of chicks as a period for making the chicks acclimated to the feeding area as will be described later. By providing such a preparatory period, it is possible to make the chicks acclimated to the feeding environment, and enable the chicks to take feed or water immediately after placement of the chicks, and thus, it is possible to improve the survival rate in the chick period.

On the other hand, in broiler production, there is a case that a broiler dies. Such an individual leads an economical loss (so-called eat-and-run) that a broiler produced with an investment of a production cost for certain feeds in the poultry production dies before shipment. Provision of the preparatory period makes it possible to presume the individual that will die during raising, and leads to the possibility of preventing economical loss in the broiler production.

For example, if the feeding area is illuminated with red light which is non-blue light (for example, having a peak wavelength within the range from 560 nm to 780 nm) in the preparatory period, the light for illuminating the feeding area is brighter than blue light for chicks, so that the chicks are more likely to take feed or water on and after placement of the chicks. In other words, since it is possible to make chicks acclimated to the feeding environment in early stage in the period of placement of the chicks, the survival rate in the chick period can be further improved.

The light for illumination in the preparatory period is not limited to the above color, and for example, green (wavelength having a peak wavelength within the range from 490 nm to 560 nm) may be employed.

(Regarding Illuminance)

In particular, it is preferred to adjust the illuminance of the light for illuminating the feeding area in the late raising period to be higher than that in the early raising period. Concretely, the illuminance of the light for illuminating the feeding area is preferably more than or equal to 30 1×. By adjusting the illuminance of the light for illuminating the feeding area in the late raising period to fall within the above range of illuminance, it is possible to raise the broilers in more excited condition. In other words, since the broilers can be caused to take more feeds by bringing the feeding area to have an illuminance (or brightness) of the aforementioned range, it is possible to raise the broilers to securely have a desired body weight at a desired shipment time.

For ease of grasping the influence of illuminance on the poultry, illuminance is preferably measured at substantially the same level with the withers height of the fed poultry from the floor face of the feeding area, or at substantially the same level with the height of eye in normal conditions. For example, in the case of broilers, illuminance is measured at the site located about 200 mm above the floor face.

For example, when the feeding area is illuminated with blue light throughout the raising period, it is possible to further increase the body weight of broilers at the time of shipment by adjusting the illuminance of the blue light for illuminating the feeding area in the late raising period to fall within the above range of illuminance. As a result, it is possible to further increase the value of the average body weight at shipment in the production score. Furthermore, it is possible to cause the broilers to take more feeds, and to make the late raising period shorter, and thus it is possible to further decrease the value of the day of age at shipment.

Also, it is preferred that the illuminance of the light for illuminating the feeding area is less than or equal to 15 1× in the early raising period. When the illuminance of the light for illuminating the feeding area in the early raising period is adjusted to the illuminance within the above range, the chicks are raised at an illuminance with which behavior of the chicks can be restricted, and the mortality of the broiler chicks can be further reduced, and healthier chicks can be raised, and thus physical conditions of the grown broilers are further improved.

Furthermore, when the illuminance of the light for illuminating the feeding area in the transition period is adjusted to more than or equal to the illuminance in the early raising period and to less than or equal to the illuminance in the late raising period, illuminance of the light for illuminating the feeding area can be changed more smoothly between the early raising period and the late raising period, and thus the feeding environment can be made into a better condition.

For example, when the illuminance in the early raising period is about 15 1×, and the illuminance in the late raising period is about 30 1×, the illuminance in the transition period is adjusted to about 23 1×.

In summary, in the method for producing poultry of the present invention, broiler chicks are placed in an open poultry house, and light emitted from a LED light source is adjusted so that a predetermined color tone and lighting control are achieved in a feeding area. This LED light source is provided with a plurality of illuminants. The plural illuminants respectively have individual light control and toning functions, and can be adjusted so that the light emitted from the LED light source has desired color tone and illuminance.

For example, first, in the preparatory period, red light (wavelength having a peak wavelength within the range from about 560 nm to 780 nm) is emitted to make the chicks acclimated to the feeding environment in the early stage of placement. Then the feeding area is illuminated with blue light (wavelength having a peak wavelength within the range from about 380 nm to 490 nm) throughout the raising period. Then, in the transition period on or after the early raising period, green light (wavelength having a peak wavelength within the range from about 490 nm to 560 nm) in addition to the blue light is applied so that the feeding area is illuminated with pale blue light. Then, in the late raising period on or after the transition period, red light (wavelength having a peak wavelength within the range from about 560 nm to 780 nm) in addition to the blue light and the green light is applied so that the feeding area is illuminated with white light. The illuminance of the light illuminating the feeding area is adjusted to about 15 1× (early raising period), about 23 1× (transition period) and about 30 1× (late raising period), respectively in the order of the early raising period, the transition period and the late raising period.

In the open poultry house, the light illuminating the feeding area in the poultry house preferably consists only of the light emitted from the aforementioned light source, but the case where the light contains some external light may be allowed. In this case, illumination is conducted so that the light quantity emitted from the aforementioned light source is larger than the light quantity of the external light in the light for illuminating the feeding area.

### EXAMPLES

### Example 1

The validity of the method for producing poultry of the present invention was verified.

In the experiment, the following evaluations were made on the basis of the color tone and/or illuminance of the light illuminating the feeding area.

The following experiments were conducted to verify the validity of the present invention:
(1) Characteristic test based on color tone, and
(2) Raising evaluation (production test).

The apparatus, equipment and condition and so on used in the experiment are as follows.

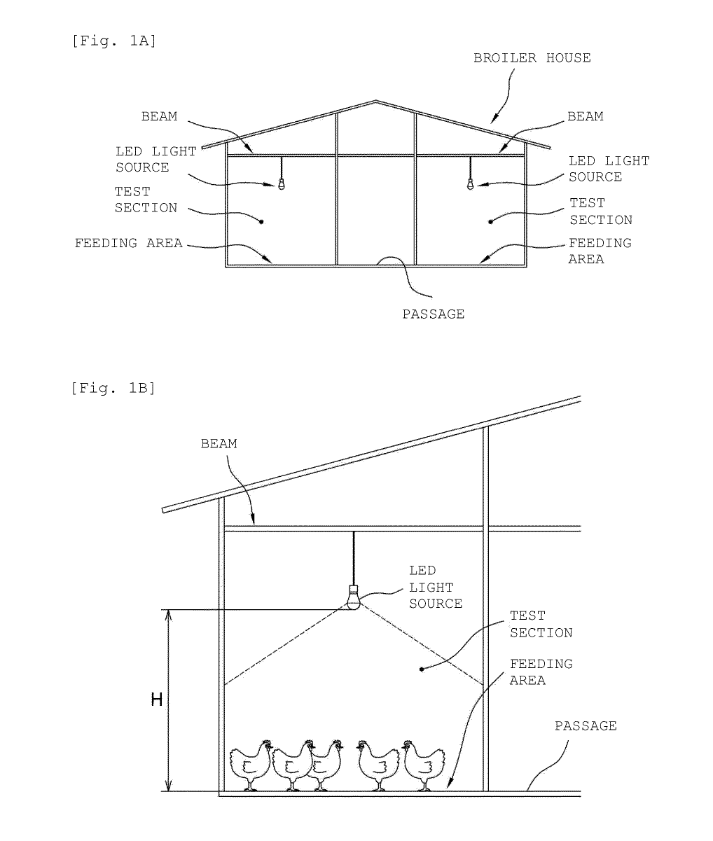

As shown in FIG. 1, a common broiler house was used as a poultry house. The broiler house used herein had test sections arranged on both sides across a passage. For example, each test section used herein had a feeding area having a frontage of 2.0 m and a depth of 2.16 m (floor area of the feeding area is 4.32 m²).

As the light source, a bulb-shaped LED light source was prepared and used. The LED light source used herein had a substrate having a function of driving the light source. The substrate used herein had a plurality of illuminants that are electrically connected with its surface (LED device (product of NICHIA CORPORATION, models: NCSR119 (red light), NCSB119 (blue light), NCSG119 (green light))) arranged linearly at predetermined intervals (about 10 mm). The substrate used herein had a function of adjusting the light emitted by the LED device into a desired color of light (toning function), and a function of adjusting to have a desired brightness (illuminance) (light controlling function). In brief, the LED light source used herein can adjust the color of light emitted from the LED light source into a desired color (color tone) by adding green (G) and red (R) sequentially to the blue (B) in a predetermined proportion.

When the light in one of neighboring test sections can influence on the feeding area of the other test section, a bulb-shaped LED light source equipped with an anti-diffusion cover provided to cover the LED light source may be used. Since use of such a bulb-shaped LED light source can prevent light from diffusing into other feeding area, it is possible to obtain a result taking only the light illuminating the feeding area into account. Adjustment to desired white light is facilitated when the anti-diffusion cover has a reflective material on its inner face.

In the case of a LED light source with invariable tone that emits white light, the one having a predetermined number of LED devices that emit only white light arranged on a substrate may be used.

In using a LED light source with variable tone, it is possible to adjust to the white light having a color temperature of 6500 kelvins by setting outputs of the LED devices at 5 for blue light, 9 for red light and 9 for green light when the maximum output of each LED light emitting device emitting blue light, red light or green light is taken as 10.

When the illuminance is dark white light, the colors may be mixed at 5%, 9% and 9%, respectively, and when the illumination is bright white light, the colors may be mixed at 50%, 90% and 90%, respectively.

The illuminance was determined by measuring illuminance at the position of about 200 mm above the floor in the feeding area directly under the light source by using an illuminometer (product of Konica Minolta Sensing Ltd., model: T-10).

The light source was disposed in each feeding area as shown in FIG. 1, so that

disposition height H: about 1.4 m above the floor face of the feeding area, and

disposed number: one per about 4 m² of feeding area in the feeding area.

Regarding illumination time of light to the feeding area, lighted time and unlighted time were adjusted so that:

lighted time: 0:00-9:00, 16:30-23:00

unlighted time: 9:00-16:30, 23:00-0:00

in the period until 3 weeks of age after placement of chicks, and

lighted time: 3:00-9:00, 16:30-23:00

unlighted time: 9:00-16:30, 23:00-3:00

in the period between 3 weeks of age and 7 weeks of age.

In (1) Characteristic test based on color tone, the illumination time from the placement of chicks to 3 weeks of age is referred to as placement to 2 weeks of age, and the illumination time from 3 weeks of age to 7 weeks of age is referred to as 2 weeks of age to 6 weeks of age.

The period from placement of chicks to 3 weeks of age during which the chicks molt is referred to as an early raising period, the period from 3 weeks of age to 5 weeks of age is referred to as a transition period, and the period from 5 weeks of age to 7 weeks of age is referred to as a late raising period.

The test chickens used in the experiment were broilers (Chunky broiler) (hereinafter, simply referred to as broiler).

A production score was calculated by (average body weight at measurement×rate of raising)/(feed conversion rate×day of age at measurement)×100.

Here, the rate of raising (%) was calculated by the number of fed broilers at measurement/the number of chicks at placement×100. The feed conversion rate was calculated as a feed amount required for increasing the body weight of broiler by 1 gram.

(1) Characteristic Test Based on Color Tone

We confirmed that the blue light for illuminating the feeding area of the present invention is able to raise the broilers in the condition that the rate of raising is high, in comparison with the light of other colors (red light, green light and white light). Concretely, we confirmed that by illuminating the feeding area with blue light, among the three primary colors of light, it is possible to raise the broilers with little falling dead.

The broiler house used in the experiment was divided into feeding areas of four sections (three primary colors of light+white) on the south side and the north side across the passage. Each feeding area had a feeding floor area of 4.32 m², and one LED light source was installed in each feeding area.

The feeding areas are referred to as a blue LED section, a red LED section, a green LED section and a white LED section, according to the light illuminating the respective feeding areas.

The wavelength of the light illuminating the feeding area in each test section is as follows: the blue LED section (blue light having a peak wavelength within the range from 380 nm to 490 nm), the red LED section (red light having a peak wavelength within the range from 560 nm to 780nm), the green LED section (green light having a peak wavelength within the range from 490 nm to 560 nm) and the white LED section. As the LED light source in the white LED section, a white LED device was used. At this time, the color temperature of the white LED device was adjusted within the range from 5,000 kelvins to 7,000 kelvins.

In this experiment, the raising period was 6 weeks during which a general body weight at shipment of broiler was achieved.

The broiler chicks were placed into the feeding areas (placement of chicks) so that the fed number in each test section was about 10 to 15 chicks/m² by broiler density (at shipment).

For example, each one test section was arranged on the south side and the north side, and 50 broiler chicks (25 male chicks, 25 female chicks) were placed in the feeding area in the south test section, and 52 broiler chicks (26 male chicks, 26 female chicks) were placed in the feeding area in the north test section.

(I) Regarding Rate of Raising

The number of died chicks in every week of age in each color tone is shown in Table 1.

TABLE 1

| WEEK OF AGE | NUMBER OF DIED CHICKS (CHICKS) | | | |
|---|---|---|---|---|
| (WEEK) | BLUE | RED | GREEN | WHITE |
| 1 | 0 | 0 | 0 | 0 |
| 2 | 0 | 2 | 1 | 0 |
| 3 | 0 | 1 | 2 | 3 |
| 4 | 0 | 1 | 0 | 0 |
| 5 | 0 | 1 | 0 | 2 |
| 6 | 2 | 0 | 1 | 1 |
| TOTAL | 2 | 5 | 4 | 6 |
| RATE OF | 98.0 | 95.1 | 96.1 | 94.1 |
| RAISING (%) | | | | |

As shown in Table 1, it was confirmed that the rate of raising at 6 weeks of age corresponding to the week of age at shipment is higher under the blue light than under the light of other color (red light, green light and white light).

In particular, no broiler died when the feeding area is illuminated with the blue light in the chick period from 0 week of age (placement of chicks) to 3 weeks of age (early raising period), however, death of broiler was observed irrespectively of the week of age under the light of other color.

The experimental result of Table 1 revealed that by illuminating the feeding area with blue light, it is possible to raise the broilers with a higher rate of raising compared with illumination with light of other color. Particularly, it was confirmed that by illuminating the feeding area with blue light, it is possible to prevent the chicks from dying at a probability of 100% in the chick period from placement of chicks to 3 weeks of age (early raising period) during which the chicks are especially sensitive to the feeding environment.

This reveals that chicks can be raised with a high rate of raising in the early raising period by illuminating the feeding area with blue light.

It was also confirmed that even in the period on or after 3 weeks of age, or in the period after the broilers have grown, a higher rate of raising can be maintained by illuminating the feeding area with blue light than with light of other color. In other words, it was confirmed that a high rate of raising can be maintained throughout the raising period.

This suggests that sudden death or metabolic disorder associated with abrupt and excessive eating behavior can be prevented, and the broilers can be raised in healthy conditions since illumination of the feeding area with blue light in the early raising period can restrict the behavior of chicks.

On the other hand, it was confirmed that a half or a half or more of the entire number of deaths are deaths in the early raising period by illuminating the feeding area with light of other color. Also it was confirmed that broilers die in the period on or after the early raising period irrespectively of the week of age.

This suggests that illumination of the feeding area with light of other color in the early raising period of chicks that are sensitive to stress, caused some stress on the chicks. It is also suggested that when the chicks were raised in such an environment, they were raised in the condition of having metabolic disorder or the like, and thus the broilers died in the period on or after the early raising period irrespectively of the week of age.

(II) Regarding Average Body Weight

An average body weight in every week of age in each color tone is shown in Table 2.

TABLE 2

| | AVERAGE BODY WEIGHT | | | | |
|---|---|---|---|---|---|
| | 0 | 1 | 3 | 5 | 6 |
| | WEEK | WEEK | WEEKS | WEEKS | WEEKS |
| | OF AGE | OF AGE | OF AGE | OF AGE | OF AGE |
| BLUE | 40 | 180 | 947 | 2178 | 2709 |
| RED | 40 | 179 | 921 | 2263 | 2877 |
| GREEN | 40 | 172 | 937 | 2223 | 2844 |
| WHITE | 40 | 176 | 956 | 2261 | 2896 |

As shown in Table 2, it was confirmed that in the blue light, the average body weight of broiler chicks increases predominantly or equivalently to other colors until the early raising period, however, in the period on or after this period, the rate of change in average body weight become dull in comparison with other colors. That is, it was confirmed that by illuminating the feeding area with blue light that restricts behavior of chicks as confirmed in the above (I), it is possible to favorably increase the average body weight of the chicks in the early raising period.

On the other hand, it was confirmed that, in the period on or after the early raising period, the average body weight can be increased compared with the case of illuminating with blue light by illuminating the feeding area with light of other color for the chicks as confirmed in the above (I). Particularly, it was confirmed that the average body weight of the broilers can be further increased by illuminating the feeding area with white light. In other words, it was confirmed that the body weight at shipment can be improved by raising the broilers under light of other color than blue to allow them to take more feeds in the period on or after the early raising period (especially in late period).

These results reveal that by illuminating the feeding area with blue light, it is possible to create the feeding environment where behavior of the broilers can be restricted.

As a result, it was confirmed that chicks can be raised with a rate of raising of 100%, particularly in the chick period in which they are physically weak (early raising period). In other words, it was confirmed that healthy chicks can be raised by illuminating the feeding area with blue light.

On the other hand, it was confirmed that, in the broilers in the late raising period, the average body weight can be increased by raising them under light of other color to allow them to take more feeds.

Therefore, it was confirmed that by illuminating the feeding area with blue light in the early raising period, it is possible to raise healthy chicks, and to raise the broilers resistant to a certain amount of stress when the chicks have grown.

In other words, it was confirmed that by illuminating the feeding area with blue light, death of a broiler probably caused by excessive and abrupt eating behavior in the growing stage can be prevented. In brief, it was confirmed that it is possible to prevent an economical loss that a broiler to which a certain production cost for certain feeds is applied dies before shipment.

On the other hand, it was suggested that in the late raising period after the broilers have grown healthily, it is possible to further increase the average body weight by contrarily raising under light of other color that promotes (stimulates) behavior of the broilers.

(2) Raising Evaluation (Production Test)

From the aforementioned results of characteristic test, it was suggested that by using the method for producing poultry of the present invention, it is possible to produce the broilers with a high raising performance. In other words, it was suggested that by illuminating the feeding area with blue light, and restricting behavior of the broilers (concretely, eating behavior), it is possible to raise healthy broilers, and in the late raising period, it is possible to cause the broilers to take more feeds by promoting (stimulating) behavior (eating behavior) by light of other color, and to increase the average body weight at shipment.

On the basis of these results of the characteristic test, raising evaluation (production test) was conducted in the following manner.

We verified whether it is possible to maintain high rate of raising throughout the raising period and to further increase the average body weight of broilers at shipment by illuminating the feeding area with blue light in the early raising period and with white light in the late raising period. In other words, we verified whether it is possible to produce broilers with a high production score by using the method for producing poultry of the present invention. As a result, we confirmed that broilers can be produced with a high production score by illuminating the feeding area with blue light in the early raising period, and by illuminating the feeding area with white light in the late raising period.

The broiler house, the LED light source, the illumination lighting time and the test chickens used in the experiment are the same as those of the conditions used in (1) Characteristic test as described above.

In the experiment, the following sections are examined: a white LED section illuminated with white light (color temperature of 5,000 kelvins to 7,000 kelvins); a blue→white LED section I in which the color tone is changed to white light from blue light (blue light: blue light having a peak wavelength within the range from 380 nm to 490 nm, white light: mixed light of blue light having a peak wavelength within the range from 380 nm to 490 nm, green light having a peak wavelength within the range from 490 nm to 560 nm, and red light having a peak wavelength within the range from 560 nm to 780 nm); a blue→white LED section II in which the color tone is changed to white light from blue light (the light adjusted to be the same as that in the white LED section I); and a blue→pale blue→white LED section in which the color tone is changed from blue light to intermediate pale blue light, and then to white light (blue light: blue light having a peak wavelength within the range from 380 nm to 490 nm, pale blue light: mixed light of blue light having a peak wavelength within the range from 380 nm to 490 nm and green light having a peak wavelength within the range from 490 nm to 560 nm, white light: white light adjusted to be the same as that in the white LED section I).

As the LED light source in the white LED section, a white LED device was used.

In the experiment, the raising period was set to 7 weeks which is comparable to the raising period in common broiler production.

Timing of toning of LED light source and illuminance in the feeding area are shown in Table 3.

TABLE 3

| | | | | | | |
|---|---|---|---|---|---|---|
| 0-1 | 1-2 | 2-3 | 3-4 | 4-5 | 5-6 | 6-7 |
| WEEK | WEEKS | WEEKS | WEEKS | WEEKS | WEEKS | WEEKS |
| OF AGE | OF AGE | OF AGE | OF AGE | OF AGE | OF AGE | OF AGE |

| WHITE (W) | WHITE (W) | | | |
|---|---|---|---|---|
| BLUE → | BLUE (B) | WHITE | WHITE (RGB | WHITE (RGB |
| WHITE (RGB) I | | (RGB DARK) | INTERMEDIATE) | BRIGHT) |

| | | | |
|---|---|---|---|
| BLUE → | BLUE (B) | WHITE (RGB | WHITE (RGB |
| WHITE (RGB) II | | DARK → | BRIGHT) |
| | | INTERMEDIATE) | |

| | | | |
|---|---|---|---|
| BLUE → PALE | BLUE (B) | PALE BLUE (GB) | WHITE (RGB |
| BLUE WHITE | | | BRIGHT) |
| (RGB) | | | |

As shown in Table 3, illuminance in the feeding area in each test section was adjusted so that
(A) in the white LED section, substantially the same illuminance (30 1×) in the period of ages between 0 and 7 weeks,
(B) in the blue→white LED section, blue light (about 15 1×) in the period of ages between 0 and 3 weeks, white light (dark) (about 15 1×) in the period of ages between 3 and 4 weeks, white light (intermediate) (about 23 1×) in the period of ages between 4 and 5 weeks, and white light (bright) (30 1×) in the period of ages between 5 and 7 weeks,
(C) in the blue→white LED section II, blue light (about 15 1×) in the period of ages between 0 and 4 weeks, white light (dark) (about 15 1×) in the first half period of ages between 4 and 5 weeks and white light (intermediate) (about 23 1×) in the second half period of ages between 4 and 5 weeks, and white light (bright) (30 1×) in the period of ages between 5 and 7 weeks;
(D) in the blue→pale blue→white LED section, blue light (about 15 1×) in the period of ages between 0 and 3 weeks, pale blue light (about 23 1×) in the period of ages between 3 and 5 weeks and white light (bright) (30 1×) in the period of ages between 5 and 7 weeks.

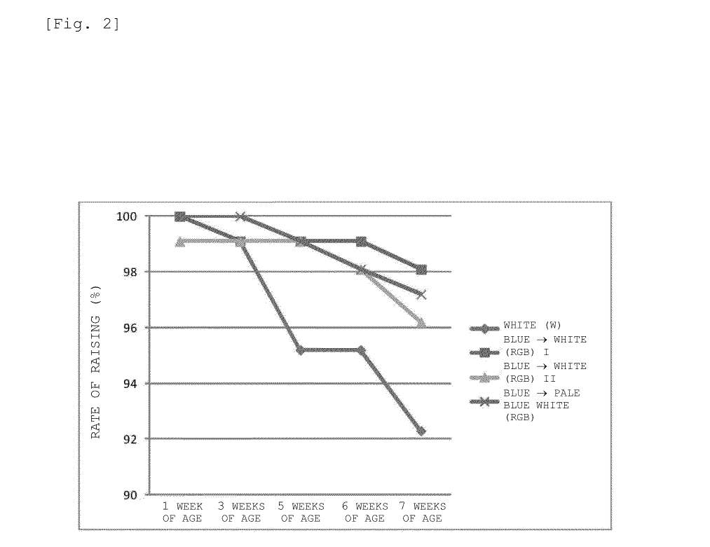

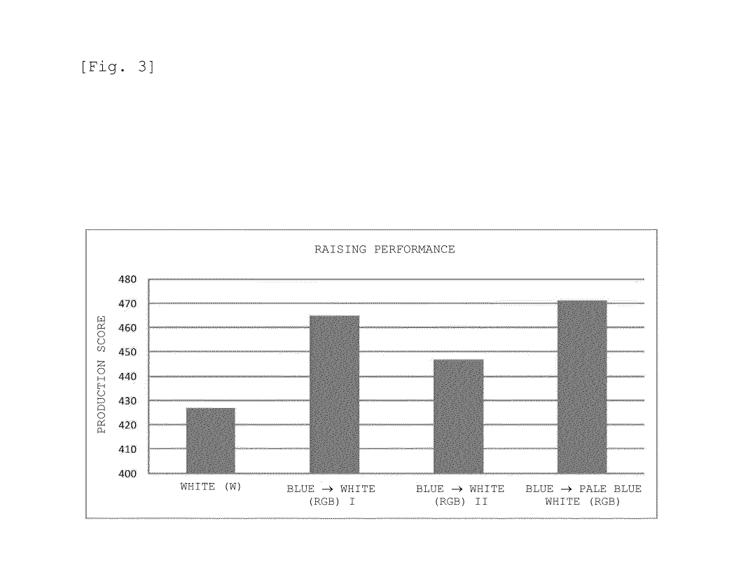

Table 4 and FIG. 2 show the result of rate of raising, Table 5 shows the result of average body weight, Table 6 shows the result of feed conversion rate, and Table 7 and FIG. 3 show the raising performance based on production score, respectively.

TABLE 4

| | RATE OF RAISING | | | | |
|---|---|---|---|---|---|
| | 0-1 | 0-3 | 0-5 | 0-6 | 0-7 |
| | WEEK | WEEKS | WEEKS | WEEKS | WEEKS |
| | OF AGE | OF AGE | OF AGE | OF AGE | OF AGE |
| WHITE (W) | 100 | 99 | 95 | 95 | 92 |
| BLUE → | 100 | 99 | 99 | 99 | 98 |
| WHITE | | | | | |
| (RGB) I | | | | | |
| BLUE → | 99 | 99 | 99 | 98 | 96 |
| WHITE | | | | | |
| (RGB) II | | | | | |
| BLUE → | 100 | 100 | 99 | 98 | 97 |
| PALE BLUE | | | | | |
| WHITE | | | | | |
| (RGB) | | | | | |

TABLE 5

| | AVERAGE BODY WEIGHT | | | | | |
|---|---|---|---|---|---|---|
| | | 1 | 3 | 5 | 6 | 7 |
| | 0 | WEEK | WEEKS | WEEKS | WEEKS | WEEKS |
| | WEEK | OF AGE | OF AGE | OF AGE | OF AGE | OF AGE |
| WHITE (W) | 40 | 185 | 1043 | 2546 | 3219 | 3792 |
| BLUE → | 40 | 192 | 1053 | 2591 | 3239 | 3860 |
| WHITE | | | | | | |
| (RGB) I | | | | | | |
| BLUE → | 40 | 188 | 1048 | 2520 | 3192 | 3751 |
| WHITE | | | | | | |
| (RGB) II | | | | | | |
| BLUE → | 40 | 186 | 1051 | 2623 | 3278 | 3907 |
| PALE BLUE | | | | | | |
| WHITE (RGB) | | | | | | |

TABLE 6

| | FEED CONVERSION RATE | | | | |
|---|---|---|---|---|---|
| | 0-1 | 0-3 | 0-5 | 0-6 | 0-7 |
| | WEEK | WEEKS | WEEKS | WEEKS | WEEKS |
| | OF AGE | OF AGE | OF AGE | OF AGE | OF AGE |
| WHITE (W) | 1.00 | 1.22 | 1.41 | 1.53 | 1.67 |
| BLUE → | 1.01 | 1.21 | 1.41 | 1.53 | 1.66 |
| WHITE | | | | | |
| (RGB) I | | | | | |
| BLUE → | 0.99 | 1.21 | 1.41 | 1.51 | 1.65 |
| WHITE | | | | | |
| (RGB) II | | | | | |
| BLUE → | 1.01 | 1.22 | 1.40 | 1.52 | 1.64 |
| PALE BLUE | | | | | |
| WHITE | | | | | |
| (RGB) | | | | | |

TABLE 7

| | PRODUCTION SCORE | | | | |
|---|---|---|---|---|---|
| | 1 | 3 | 5 | 6 | 7 |
| | WEEK | WEEKS | WEEKS | WEEKS | WEEKS |
| | OF AGE | OF AGE | OF AGE | OF AGE | OF AGE |
| WHITE (W) | 263 | 404 | 492 | 476 | 427 |
| BLUE → | 272 | 409 | 519 | 499 | 465 |
| WHITE | | | | | |
| (RGB) I | | | | | |
| BLUE → | 270 | 408 | 506 | 495 | 447 |
| WHITE | | | | | |
| (RGB) II | | | | | |
| BLUE → | 262 | 410 | 532 | 504 | 471 |
| PALE BLUE | | | | | |
| WHITE | | | | | |
| (RGB) | | | | | |

As shown in Table 4 and FIG. 2, it was confirmed that high rate of raising can be maintained throughout the raising period by illuminating the feeding area with blue light that restrict behavior of broilers in the early raising period and with white light that promotes behavior of broilers in the late raising period. In other words, it was confirmed that high rate of raising can be maintained throughout the raising period by restricting eating behavior in the early raising period and promoting eating behavior in the late raising period with the light in the feeding area.

It was confirmed that broilers can be produced with higher rates of raising in the blue→white LED section I, the blue→white LED section II and the blue→pale blue→white LED section than in the white LED section, particularly in the late raising period although the feeding environment of each test section is in approximately the same condition.

It was also confirmed that by adjusting the color tone and/or illuminance of the feeding environment in the transition period between blue light in the early raising period and white light in the late raising period to be intermediate between those in the early raising period and in the late raising period, it is possible to achieve the circumstance where abrupt environmental change for broilers does not occur. In other words, in the transition period between the early raising period and the late raising period, it was possible to create the feeding environment where stresses on chickens are little, high rate of raising can be maintained, and chickens can take more feeds in the late raising period by gentle transition of light change. This can be also confirmed from the result of average body weight in Table 5.

As shown in Table 5, it was confirmed that by adjusting the light for illuminating the feeding area in the transition period to be intermediate between those in the early raising period and in the late raising period, it is possible to produce broilers having larger average body weight at shipment (7 weeks of age) in comparison with the LED section illuminated only with white light.

A feed conversion rate in every week of age in each test section is shown in Table 6.

As shown in Table 6, it was confirmed that by adjusting the light for illuminating the feeding area in the transition period to be intermediate between those in the early raising period and in the late raising period, it is possible to reduce the feed conversion rate, or in other words, it is possible to improve the feed conversion rate at shipment (7 weeks of age) in comparison with the white LED section illuminated only with white light.

General evaluation of the foregoing raising performances is shown in Table 7 and FIG. 3.

As shown in Table 7 and FIG. 3, general evaluation of raising performances was determined on the basis of a production score.

As shown in Table 7 and FIG. 3, it was confirmed that by appropriately adjusting the color tone and/or illuminance of light for illuminating the feeding area so that the feeding environment in which behavior is restricted is changed to the feeding environment in which behavior is promoted, or by changing the condition in which eating behavior is restricted into the condition in which eating behavior is stimulated, it is possible to produce broilers with a high production score.

These results reveal that by using the method for producing poultry of the present invention, it is possible to raise broilers with high rate of raising throughout the raising period, and to produce broilers having a heavier average body weight. In other words, it was confirmed that by using the method for producing poultry of the present invention, it is possible to raise healthy broilers.

In brief, it was confirmed that by using the method for producing poultry of the present invention, it is possible to raise broilers with higher production efficiency. For example, it was confirmed that there is a possibility that broilers can be produced with a higher production score even when the broilers are raised at higher density than in conventional cases.

### INDUSTRIAL APPLICABILITY

The method for producing poultry of the present invention is suited for raising poultry in a poultry house for feeding poultry such as chickens, quails, ducks and geese.

1. A method for producing poultry in a poultry house, wherein
in an early raising period of a poultry raising period,
a feeding area for feeding the poultry is illuminated with blue light.

2. The method for producing poultry according to claim 1, wherein
the blue light is applied throughout the poultry raising period.

3. The method for producing poultry according to claim 1, wherein
in a late raising period of the poultry raising period,
the feeding area is illuminated with white light.

4. The method for producing poultry according to claim 3, wherein
in a transition period that is between the early raising period and the late raising period,
the feeding area is illuminated with light of an intermediate color that is between the blue light and the white light.

5. The method for producing poultry according to claim 1, wherein
a preparatory period is provided before the early raising period or in an initial period of the early raising period, and
the feeding area is illuminated with non-blue light in the preparatory period.

6. The method for producing poultry according to claim 1, wherein
illuminance of light for illuminating the feeding area in the late raising period is adjusted so that illuminance in the late raising period is higher than illuminance in the early raising period.

7. The method for producing poultry according to claim 6, wherein illuminance of light in the late raising period is more than or equal to 30 1×.

8. The method for producing poultry according to claim 6, wherein
illuminance of light in the early raising period is less than or equal to 15 1×.

9. The method for producing poultry according to claim 8, wherein
illuminance of light in the transition period is more than or equal to illuminance of light in the early raising period and less than or equal to illuminance of light in the late raising period.
